(19) United States
(12) Patent Application Publication
(10) Pub. No.: US 2024/0127069 A1
(43) Pub. Date: Apr. 18, 2024

(54) TAXONN: A LIGHT-WEIGHT ACCELERATOR FOR TRAINING DEEP NEURAL NETWORKS ON THE EDGE

(71) Applicant: UNIVERSITY OF LOUISIANA LAFAYETTE, Lafayette, LA (US)

(72) Inventors: Mohammadhassan NAJAF, Lafayette, LA (US); Reza HOJABR, Vancouver (CA); Kamyar GIVAKI, Tehran (IR); Kossar POURAHMADI, Baltimore, MD (US); Parsa NOORALINEJAD, Baltimore, MD (US); Ahmad KHONSARI, Tehran (IR); Dara RAHMATI, Tehran (IR)

(73) Assignee: UNIVERSITY OF LOUISIANA LAFAYETTE, Lafayette, LA (US)

(21) Appl. No.: 17/961,396

(22) Filed: Oct. 6, 2022

(51) Int. Cl. G06N 3/084; G06N 3/0464; G06N 3/063

(52) U.S. Cl. CPC G06N 3/084; G06N 3/0464; G06N 3/063

(57) ABSTRACT

An accelerator for training deep neural networks is provided. The accelerator includes a baseline architecture having an input buffer, a weight buffer, an output buffer, a buffer controller, and a two-dimensional array of processing elements. The array of processing elements is used in both convolutional and fully connected layers. The convolutional layer includes multiple filters. The output of each said filter in said convolutional layers is achieved by a weighted summation. In a preferred embodiment, each convolutional and fully connected layer is equipped with input/output buffers that fetch/store the input/output data. In a particularly preferred embodiment, each processing element can access the weight buffer that holds the weight vector.

### CROSS REFERENCE TO RELATED APPLICATIONS

This application claims benefit of priority under 35 U.S.C. § 119(e) of U.S. Ser. No. 63/253,751, filed 8 Oct. 2021, the entire contents of which is incorporated herein by reference in its entirety.

### STATEMENT REGARDING FEDERALLY SPONSORED RESEARCH OR DEVELOPMENT

This invention was supported in part by National Science Foundation Grant No. 2019511 and the Louisiana Board of Regents Support Fund No. LEQSF(2020-23)-RD-A-26.

### REFERENCE TO A “SEQUENCE LISTING,” A TABLE, OR A COMPUTER PROGRAM

Not Applicable.

### DESCRIPTION OF THE DRAWINGS

The drawings constitute a part of this specification and include exemplary embodiments of the “TaxoNN: Light-Weight Accelerator for Deep Neural Network Training” which may be embodied in various forms. It is to be understood that in some instances, various aspects of the invention may be shown exaggerated or enlarged to facilitate an understanding of the invention. Therefore, the drawings may not be to scale.

FIG. 1 depicts back-propagation in the layers of a Deep Neural Network (DNN).

FIG. 2 depicts the baseline architecture of TaxoNN to execute the inference of DNNs.

FIG. 3 depicts a timing diagram of the training process in TaxoNN.

FIG. 4 depicts the micro-architecture of a PE in TaxoNN with the training capability.

FIG. 5 depicts the network loss: (a) MNIST, (b) CIFAR10, and (c) SVHN.

### I. INTRODUCTION

Driven by the availability of large datasets, deep learning applications are increasingly growing in various fields such as speech recognition, computer vision, control and robotics. Meanwhile, time-consuming computations of Deep Neural Networks (DNNs) and the need for power-efficient hardware implementations have made the semiconductor industry rethink the customized hardware for deep learning algorithms. As a result, DNN hardware accelerators have emerged as a promising solution to tackle efficient implementation of these compute-intensive and energy-hungry algorithms.

Employing deep learning algorithms in building intelligent embedded devices that interact with the environment requires customized accelerators that support both training and inference processes. For instance, in deep reinforcement learning algorithms, an agent uses a neural network (NN) to predict the proper action regarding the current state and the reward obtained from the environment. In such algorithms a NN-based agent is interacting with the environment, the environmental conditions are changing continuously, and the training process is performed repeatedly to tune the agent. Implementing the prohibitive computations of the training process requires an efficient yet low-power trainable architecture. Although prior art accelerators have significantly improved the performance of the inference process, there is still a growing demand for low-power DNN accelerators that support both training and inference processes.

The training process can be interpreted as an optimization problem that aims to minimize an objective function (network error function) by finding a set of network parameters. Stochastic Gradient Descent (SGD) is a common approach for solving this optimization problem. SGD moves towards the optimum point in the decreasing direction of the error function's gradient. Calculating the gradients during SGD requires high-cost hardware resources which cannot be provided in embedded devices with a limited power and area budget. Therefore, adding the training capability to the conventional inference-only accelerators presents challenges. The instant invention provides a solution to enable inference-only accelerators to perform SGD computations with minimum hardware resources.

Relying on the approximate nature of NNs, several methods have been proposed by those skilled in the art for replacing floating point units of NN with low-bitwidth ones. Others skilled in the art have shown that employing low-bitwidth operations in DNN accelerators can result in a substantial power and area saving while maintaining the quality of the results. While it is more common to employ low-bitwidth data in the inference process, those skilled in the art have demonstrated that the training process (i.e., SGD) can also be performed using quantized parameters. The inventors' observations confirm that the desired accuracy can be achieved, without sacrificing the network convergence, when using low-bitwidth operations during the training process. An important point, however, is that the required bitwidth can vary from layer to layer. As one gets closer to final layers of DNNs, the extracted features become more valuable. While the early layers produce satisfying results with small bitwidths, a more precise computation is necessary in the final layers. Leveraging this observation, by proper adjustment of the bitwidth in each layer, the instant invention reduces a significant amount of power and area while maintaining the quality of the results.

The instant invention provides a novel low-cost accelerator that supports both training and inference processes. We provide a novel method to split the SGD algorithm into smaller computational elements by unrolling this compute-intensive algorithm. Using the instant invention, a fine-grained inter-layer parallelism can be used in the training process. The instant invention leverages this method and uses TaxoNN, a Light-Weight Accelerator for DNN training, which is able to perform training and inference processes using shared resources. TaxoNN utilizes an optimized datapath in a pipelined manner that minimizes the hardware cost. The inventors herein have shown that bitwidth optimization in different layers of NN can reduce the implementation cost while keeping the quality of the results. The two principal components of the instant invention are listed below.

We provide a novel heuristic method to minimize the implementation cost of the SGD algorithm by unrolling its computations. This novel method reduces the hardware cost by time-division multiplexing (TDM) of multiply-and-accumulate (MAC) units.

We provide an accelerator for DNN training, called TaxoNN, that supports training and inference using this method. TaxoNN parallelizes the SGD algorithm while minimizing the required arithmetic units.

Those skilled in the art have introduced specialized accelerators for deep learning. Motivated by the processing characteristics of DNNs, others have developed a dataflow to maximize data reuse between neural Processing Elements (PEs) and hence to minimize the energy consumption wasted on data movements. As there are various types of layers in DNNs (convolutional, pooling and fully connected), others skilled in the art have proposed new design methodologies to enable flexible data-flow mapping over neural accelerators. Those skilled in the art have also eliminated unnecessary multiplications in sparse layers and computation reuse, thereby providing promising solutions to reduce the cost of DNN accelerators.

Replacing full-precision operations with low-bitwidth ones has been used as an effective approach to save energy consumption of DNNs. Experimental observations have shown that the approximate nature of DNNs makes them tolerable to the quantization noise. Hence, costly floating-point arithmetic units are replaced by fixed-point ones at no considerable accuracy loss. Bit Fusion presents a bit-level flexible accelerator that dynamically sets the bitwidth to minimize the computation cost.

While the focus of most prior art has been on developing high-performance architectures for the inference process, those skilled in the art have also proposed accelerators for training DNNs. Some prior art uses Process-In-Memory (PIM) techniques to accelerate the training process. Performing the operations near memory helps to alleviate the data movement overhead during the DNN computations.

The prior art is void of a hardware architecture and data path that reduce the processing time of the SGD algorithm by exploiting parallelism in its heavy computations. In the instant invention, the inventors minimize the overall cost of the novel accelerator, TaxoNN, by proper adjustment of bitwidth in each layer of the network.

The training process has the most prominent role in designing an accurate DNN. The underlying principle in training methods arises from what occurs in the human brain. To distinguish a certain object, a set of various pictures demonstrating the object in different gestures are fed to the network in an iterative manner. The network gradually learns to identify an object by extracting its features in multiple iterations. By comparing the output to the desired result, the network learns how to change the parameters. This procedure continues until the network finds the best weights that maximize the recognition accuracy.

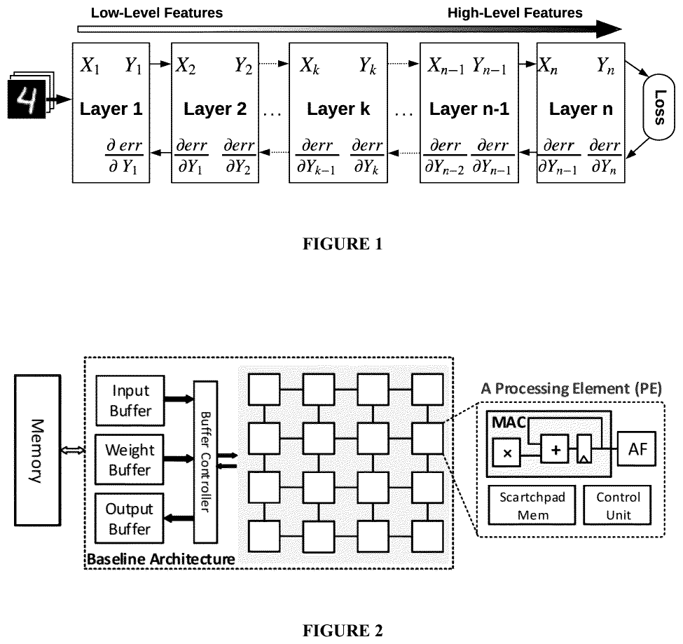

From a mathematical point of view, training procedure is performed by an error Back-Propagation (BP) method. As depicted in FIG. 1, input data is fed to the network and forwarded through the layers. The produced output is fed to a loss function to calculate the gradient of the error. The computed gradient is then back-propagated through the layers to update the weights. During back-propagation, the gradient of the error tends gradually to zero. This method is called Gradient Descent. Equation 1 shows how the weights in layer i are updated by the gradient. The learning rate is shown with α which determines the rate of network convergence by controlling the impact of gradients during the training process. Due to the large amount of data, feeding all inputs to the network is very time-consuming. Therefore, a subset of data is picked up randomly in each iteration to train the network. This method, called Stochastic Gradient Descent (SGD), is the most common approach to train DNNs.

$${W}_{i} = {W}_{i} - α \frac{\partial error}{\partial {W}_{i}} \qquad Equation 1$$

Training often takes a long time to be completed as its processing time is directly proportional to the number of layers. Conventional DNNs are composed of a large number of layers (may even more than a thousand layers). Convolutional layers constitute the largest portion of the computation load in DNNs. These layers are obligated to extract the features of the input data. Normally, the early layers extract general features that can be used in distinguishing any object. As one gets closer to final layers, more valuable features are extracted that help to recognize specific objects.

### II. THE ARCHITECTURE

### A. Inference Architecture

The baseline architecture of TaxoNN, designed to perform the inference process, is shown in FIG. 2. It is composed of a 2D array of Processing Elements (PEs) used in both convolutional and fully connected (FC) layers. In general, the output of each neuron (also known as filter in the convolutional layers) is achieved by a weighted summation,

y=f(Σᵢ₌₀^{i=k}xᵢwᵢ)

where xᵢ is the input vector, wᵢ is the weight vector and f denotes the activation function. The activation function is typically Sigmoid in FC layers and ReLU (Rectified Linear Unit) in convolutional layers. In TaxoNN, each layer is equipped with input/output buffers that fetch/store the input/output data. Each PE can access the weight buffer that holds the weight vector. To decrease the number of data accesses to the input buffer, the fetched values are forwarded through the PEs in a pipelined manner. PEs are equipped with a local scratchpad memory to hold the weights and partial results.

In the FC layer Lᵢ, the required time to complete the computations of the neurons is Nᵢ₋₁+Nᵢ clock cycles where Nᵢ₋₁+Nᵢ are the number of neurons in the (i−1)^{th} and i^{th} layers, respectively (provided that we have Nᵢ PEs). In the convolutional layer Lⱼ, where the input data size is h×w×d and the filter size is k×k×d, the convolution is achieved in kd(w−k)(h−k) clock cycles. Similar to the Row-Stationary dataflow known to those skilled in the art, each compute lane in the PE array is dedicated to a single row of the filter to maximize the data reuse in the architecture.

### B. Simplifying the SGD Algorithm

As mentioned in Equation (1), weights are updated in each layer by subtracting the term α

$$\frac{\partial error}{\partial {W}_{i}}$$

from their current value. The first step towards enabling training in the accelerator disclosed herein is to simplify the term

$$\text{?}$$

$$\text{?} \text{indicates text missing or illegible when filed}$$

to implement it with the minimum hardware resources. Leveraging the chain rule we can partition

$$\text{?}$$

$$\text{?} \text{indicates text missing or illegible when filed}$$

into three small parts as follows:

$$\frac{\partial error}{\partial {W}_{i}} = \frac{\partial error}{\partial {Y}_{i + 1}} \times \frac{\partial {Y}_{i + 1}}{\partial {Y}_{i}} \times \frac{\partial {Y}_{i}}{\partial {W}_{i}} \qquad Equation 2$$

where Yᵢ is the output of the i^{th} layer. Note that all the notations are written in the matrix form. The terms

$$\text{?}$$

$$\text{?} \text{indicates text missing or illegible when filed}$$

can be further expanded as follows.

$$\frac{\partial {Y}_{i + 1}}{\partial {Y}_{i}} = \frac{\partial {f}_{i + 1} ( {W}_{i + 1} {Y}_{i} )}{\partial {Y}_{i}} = {W}_{i + 1} {f}_{i + 1}^{′} ( {W}_{i + 1} {Y}_{i} ) \qquad Equation 3$$

$$\frac{\partial {Y}_{i}}{\partial {W}_{i}} = \frac{\partial {f}_{i} ( {W}_{i} {Y}_{i - 1} )}{\partial {W}_{i}} = {Y}_{i - 1} {f}_{i}^{′} ( {W}_{i} {Y}_{i - 1} ) \qquad Equation 4$$

where fᵢ₊₁(⋅) denotes the activation function of the (i+1)^{th} layer and f′ refers to the derivation of the activation function. Combining Equation (3) and Equation (4) leads to Equation (5).

$$\frac{\partial error}{\partial {W}_{i}} = \frac{\partial error}{\partial {Y}_{i + 1}} \times {f}_{i + 1}^{′} \times {W}_{i + 1} \times {f}_{i}^{′} \times {Y}_{i - 1} \qquad Equation 5$$

We define Gᵢ₊₁ as the product of the first two terms in the right hand side (RHS) of Equation (5) that is computed in the (i+1)^{th} layer and passed backward to the i^{th} layer.

$${G}_{i + 1} = \frac{\partial error}{\partial {Y}_{i + 1}} \times {f}_{i + 1}^{′} \qquad Equation 6$$

Clearly, the input of i^{th} layer is the output of (i−1)^{th}. Xᵢ=Yᵢ₋₁, where Xᵢ is the input of i^{th} layer). As a result, we can rewrite Equation (2) as follows:

$$\frac{\partial error}{\partial {W}_{i}} = {G}_{i + 1} \times {W}_{i + 1} \times {f}_{i}^{′} \times {X}_{i} \qquad Equation 7$$

To facilitate the hardware implementation, Equation (7) can be split into Equation (8) and Equation (9). As shown in Equation (9), multiplying Equation (8) by the input of i^{th} layer, Xᵢ, results in term

$$\text{?}$$

$$\text{?} \text{indicates text missing or illegible when filed}$$

### in Equation (1).

$${G}_{i} = {G}_{i + 1} \times {W}_{i + 1} \times {f}_{i}^{′} \qquad Equation 8$$

$$\frac{\partial error}{\partial {W}_{i}} = {G}_{i} \times {X}_{i} \qquad Equation 9$$

Consequently, Gᵢ has a key role in the training process. As shown in Equation (8), Gᵢ is achieved recursively by calculating in each layer and passing backward to the previous layer. We use this unrolling method to distinguish between the operations in the SGD and to properly map them to the hardware resources.

### C. Training Architecture

To implement the BP computations, the baseline architecture must be modified by adding some simple logical components. FIG. 4 illustrates the micro-architecture of the PEs in TaxoNN. The gray components are added to the baseline architecture to enable training. To minimize the needed resources, we employ a TDM approach to improve the resource utilization of the main components (e.g., the multipliers) in the datapath. In what follows, we describe each component in detail.

Multiplexers. As depicted in FIG. 4, the architecture is equipped with three multiplexers to enable TDM. The inference process is still performed using the main multiplier. All the needed parameters of Equation (8) and Equation (9) can be provided by a proper timing management of MUX1, MUX2 and the multiplier as follows:
(1^{st}) MUX1 provides Gᵢ₊₁ and MUX2 provides Wᵢ₊₁. Then, Gᵢ₊₁×Wᵢ₊₁ will be calculated and stored in register R1.
(2^{nd}) MUX1 forwards f′ᵢ and MUX2 forwards Gᵢ₊₁×Wᵢ₊₁ to the multiplier to calculate Gᵢ₊₁₌Gᵢ₊₁×Wᵢ₊₁×f′ᵢ.
(3^{rd}) MUX1 forwards Xᵢ to multiply it by Gᵢ and hence produce

$$\frac{\partial error}{\partial {W}_{i}} .$$

(4^{th}) Finally, the result is multiplied by the learning rate, α, that is already stored in a register behind MUX1.

In this manner, −α

$$\text{?}$$

$$\text{?} \text{indicates text missing or illegible when filed}$$

as the most important parameter for updating the weights, is prepared through a TDM of the PE's multiplier. Note that Gᵢ₊₁ and Wᵢ₊₁ have been provided and sent to the current layer by the (i+1)^{th} layer. Since all the computations are done in the matrix form, calculating Gᵢ₊₁×Wᵢ₊₁ needs Nᵢ₊₁ cycles where Nᵢ₊₁ is the number of neurons in the (i+1)^{th} layer. After each multiplication, the result is accumulated in the corresponding register.

Activation Function. The activation function unit of the baseline architecture (FIG. 2) is equipped with an internal unit to calculate the derivation of the activation functions. There are three types of activation functions which are commonly used in the modern DNNs: ReLU, Sigmoid and tanh. The derivation of sigmoid σ(x) can be easily achieved by σ′(x)=σ(x)(1−σ(x)). Also, tanh is simply achieved from σ(x) as tanh(x)=2σ(2x) and consequently, tanh′(x) can be achieved as tanh′(x)=4σ′(2x). Finally, the derivation of the ReLU is 0 for negative inputs and 1 for positive ones.

Global Multiplier. In TaxoNN, each layer i has a single global multiplier to produce Gᵢ. This multiplier is shared between all the neurons of the layer. Therefore, the number of cycles needed to produce G, equals the number of neurons in that layer. Consequently, the following components are added to the baseline PE: (i) three multiplexers, (ii) five registers (located in the scratchpad memory to hold the intermediate values during training), and (iii) activation function's derivation unit. The overhead cost of these components is discussed later.

### D. Timing and Pipeline

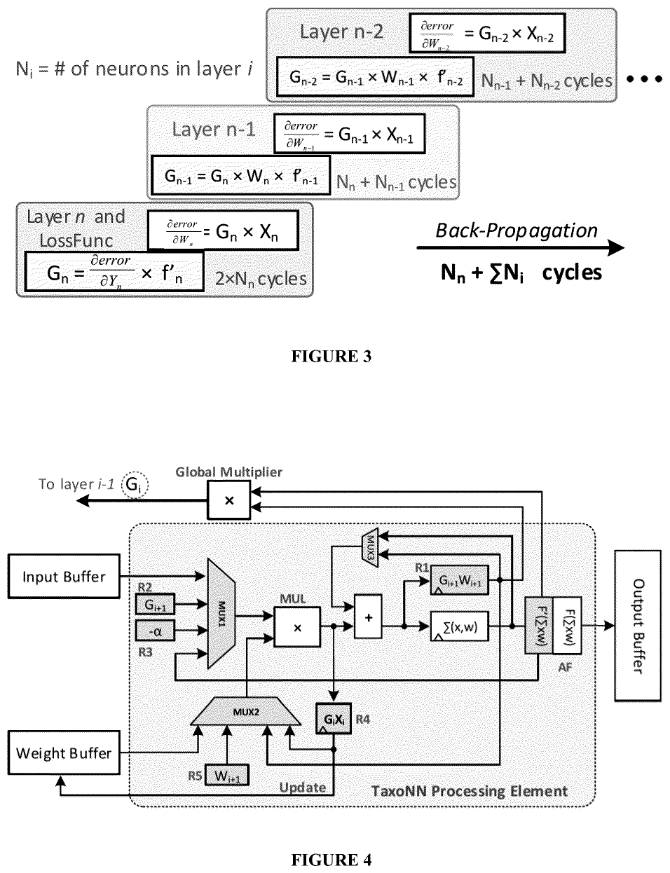

TaxoNN benefits from an optimized and pipelined architecture. FIG. 3 shows the timing diagram of the training process composed of the forwarding phase followed by the error BP and weight updating. As previously mentioned, Gᵢ is the main precedence for calculating −α

$$\text{?}$$

$$\text{?} \text{indicates text missing or illegible when filed}$$

In layer i, Gᵢ is a vector of size Nᵢ, where Nᵢ is the number of neurons in that layer. Whenever G_{i,1} (the first element of the matrix Gᵢ) becomes ready, it will be sent to the previous layer, Lᵢ₋₁, that needs the elements of Gᵢ to calculate

$$\text{?}$$

$$\text{?} \text{indicates text missing or illegible when filed}$$

Therefore, producing

$$\text{?}$$

$$\text{?} \text{indicates text missing or illegible when filed}$$

has a timing overlap with producing Gᵢ in the (i)^{th} layer. Leveraging this pipelining, TaxoNN performs an iteration of the BP in Nₙ+Σᵢ₌₁ⁱ⁼ⁿ Nᵢ clock cycles, where n is the number of layers. The extra Nₙ is for the computations of the loss function and is equal to the processing time of the last layer (n^{th} layer).

### E. Performance Evaluation

The inventors used the LeNet architecture to evaluate the performance of TaxoNN using MNIST, CIFAR10 and SVHN datasets. The inventors extracted the results of full-precision computations using TensorFlow. The inventors analyzed TaxoNN in terms of accuracy, network convergence, and hardware cost.

TABLE I
THE NETWORK ACCURACY (%) OF DIFFERENT BITWIDTH
VERSUS THE FLOATING-POINT IMPLEMENTATION.

| | | | Full- |
|---|---|---|---|
| | | TaxoNN | precision |
| Dataset | Precision per Layer (I, F) | Accuracy | Accuracy |
| MNIST | (2, 12)(2, 12)(2, 12)(1, 12)(3, 10) | 99.1 | 99.4 |
| CIFAR10 | (2, 10)(2, 11)(1, 10)(1, 13)(2, 13) | 84.1 | 85.4 |
| SVHN | (1, 12)(2, 12)(2, 12)(2, 11)(4, 12) | 94.7 | 96.0 |

TABLE II
THE AREA (um² × 10³) OF A PROCESSING ELEMENT
OF TAXONN VERSUS THAT OF THE BASELINE ARCHITECTURE.

| | | | | | | | | | | |
|---|---|---|---|---|---|---|---|---|---|---|
| Bitwidth | 21 | 20 | 19 | 18 | 17 | 16 | 15 | 14 | 13 | Average |
| Eyeriss | 14.3 | 13.1 | 11.8 | 11.1 | 10.6 | 10.1 | 9.7 | 9.0 | 8.1 | Area |
| TaxoNN | 15.5 | 14.3 | 12.9 | 12.1 | 11.7 | 11.2 | 10.6 | 9.9 | 9.0 | Overhead |
| Overhead | 8.3% | 9.2% | 9.1% | 8.6% | 10.0% | 10.8% | 8.8% | 9.8% | 10.5% | 9.5% |

### F. Bitwidth Optimization

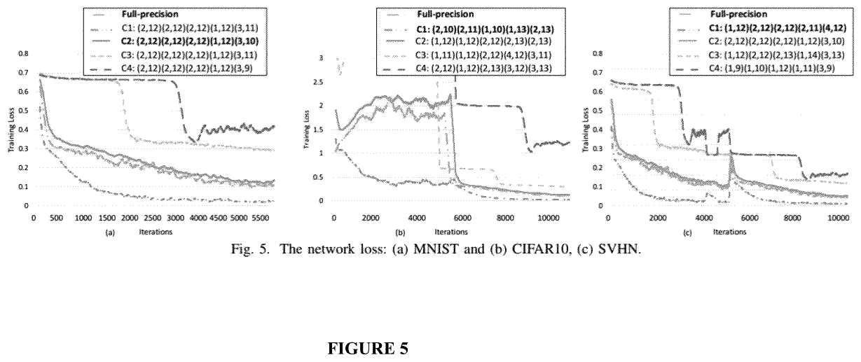

FIG. 5 demonstrates the network loss during different iterations of the training process using TaxoNN with different bitwidths (optimized for each layer) versus the case of training using the full-precision implementation. MNIST and SVHN are two datasets consist of 28×28 images from hand-written digits (0‥9) and house numbers, respectively. CIFAR10 is a set of 32×32 color images in 10 classes. The training performance is evaluated over 10,000 test images and the network accuracies are extracted by TensorFlow.

The results shown in FIG. 5 confirm that the low-bitwidth training can have a comparable accuracy for the same number of iterations. The optimum bitwidth for each layer can be different from other layers. For each dataset, the inventors evaluated the network accuracy for a large number of design points. FIG. 5 shows four design points for each dataset, each point representing the adopted precision for a layer. The number representation (I,F) indicates a fixed-point number with I bits for the integer part and F bits for the fractional part.

For instance, during the training of MNIST, the configuration set C2 converges in a manner similar to the floating-point implementation. Lower bitwidths, however, may cause under-fitting. The speed of the network convergence gets reduced as the bitwidth gets shorter. This phenomenon implies that the network confidence is directly related to the precision of the arithmetic operations. An observation is that there is a lower bound that limits the bitwidth of the training. The bitwidths lower than these thresholds cause under-fitting while the bitwidths higher than them are not necessary and will only cost additional area and power consumption.

Table I shows the neural network accuracy when using TaxoNN with various bitwidths compared to the case of using 32-bit floating-point implementation. Decreasing the bitwidth down to the identified numbers in each configuration set has no considerable impact on the network accuracy. Using a bitwidth lower than the specified one in the configuration sets results in a dramatic accuracy loss as the network cannot converge to the desired point.

TABLE III
THE POWER CONSUMPTION (mW) OF A PROCESSING ELEMENT
OF TAXONN VERSUS THAT OF THE BASELINE ARCHITECTURE.

| | | | | | | | | | | |
|---|---|---|---|---|---|---|---|---|---|---|
| Bitwidth | 21 | 20 | 19 | 18 | 17 | 16 | 15 | 14 | 13 | Average |
| Eyeriss | 4.54 | 4.48 | 4.42 | 4.31 | 4.22 | 4.10 | 3.98 | 3.88 | 3.75 | Power |
| TaxoNN | 4.84 | 4.78 | 4.70 | 4.65 | 4.49 | 4.31 | 4.15 | 4.13 | 4.04 | Overhead |
| Overhead | 6.5% | 6.7% | 6.2% | 17.9% | 6.5% | 5.2% | 4.3% | 6.5% | 7.7% | 6.4% |

TABLE IV
POWER AND AREA REDUCTION OF TAXONN COMPARED
TO THE FULL-PRECISION TRAINING IMPLEMENTATION

| Dataset | Power Reduction | Area Reduction |
|---|---|---|
| MNIST | 2.1× | 1.7× |
| CIFAR10 | 2.3× | 1.8× |
| SVHN | 1.9× | 1.5× |

### G. Hardware Cost

To evaluate the hardware cost of the proposed architecture, we implemented TaxoNN in RTL Verilog and synthesized using the Synopsys Design Compiler with a 45-nm gate library. Table II shows the area cost of the synthesized TaxoNN PE (which supports training) versus the state-of-the-art accelerator, as the baseline architecture (without supporting training). The average area overhead compared to the state-of-the-art architecture is less than 10%. The activation functions' derivation unit contributed the most portion of this area overhead and the other units such as the multiplexers had a negligible cost.

Table III shows the power consumption of TaxoNN PE compared to that of the state-of-the-art architecture (without supporting training) using fixed-point operations. As can be seen, the power consumption is not a concern for TaxoNN due to its pipelines and regular structure. The synthesis results show that the power consumption is, on average, less than 7% over that of the baseline architecture. Table IV summarizes the overall power and area improvement offered by TaxoNN with low-bitwidth operations compared to the full-precision architecture.

Moreover, the processing cycles needed for the back-propagation are relatively close to that of feed-forward. Therefore, TaxoNN improves the energy consumption of the training process. These advantages make TaxoNN an appealing accelerator for embedded devices with tight energy constraints

### H. Conclusions

The lightweight DNN accelerator disclosed herein, called TaxoNN, supports both inference and training processes. The instant invention provides a novel method to unroll and parallelize the SGD computations. Using this method, the inventors disclosed a fine-grained and optimized datapath to perform the matrix operations of SGD. TaxoNN considerably reduces the computation resources required in DNN training by reusing the arithmetic units used in the inference. The inventors evaluated TaxoNN with low-bitwidth operations for each layer. The proposed accelerator offers 1.65× area and 2.1× power saving at the cost of, on average, 0.97% higher misclassification rate compared to the full-precision implementation.

The subject matter of the present invention is described with specificity herein to meet statutory requirements. However, the description itself is not intended to necessarily limit the scope of claims. Rather, the claimed subject matter might be embodied in other ways to include different steps or combinations of steps similar to the ones described in this document, in conjunction with other present or future technologies.

1. An accelerator for training deep neural networks, comprising:
(1) A baseline architecture having an input buffer, a weight buffer, an output buffer, a buffer controller, and a 2D array of processing elements used in both convolutional and fully connected layers, said convolutional layer including a plurality of filters;
(2) and wherein the output of each said filter in said convolutional layers is achieved by a weighted summation,
y=f(Σᵢ₌₀^{i=k}xᵢwᵢ)
where xᵢ is the input vector, wᵢ is the weight vector and f denotes an activation function.

2. The accelerator in claim 1, wherein each said convolutional and fully connected layer is equipped with input/output buffers that fetch/store the input/output data.

3. The accelerator in claim 2, wherein each said processing element can access the weight buffer that holds the weight vector.

4. The accelerator in claim 3, further comprising means for forwarding fetched values in the input/out buffers through said processing elements in a pipelined manner.

5. The accelerator in claim 4, wherein said processing elements are equipped with a local scratchpad memory to hold weights and partial results.

6. A method for training deep neural networks with an accelerator, comprising:
providing an accelerator comprising:
a. A baseline architecture having an input buffer, a weight buffer, an output buffer, a buffer controller, and a 2D array of processing elements used in both convolutional and fully connected layers, said convolutional layer including a plurality of filters;
b. and wherein the output of each said filter in said convolutional layers is achieved by a weighted summation,
y=f(Σᵢ₌₀^{i=k}xᵢwᵢ)
where xᵢ is the input vector, wᵢ is the weight vector and f denotes an activation function.

7. The method in claim 6, wherein each said convolutional and fully connected layer is equipped with input/output buffers that fetch/store the input/output data.

8. The method in claim 7, wherein each said processing element can access the weight buffer that holds the weight vector.

9. The method in claim 8, wherein said accelerator further comprises means for forwarding fetched values in the input/out buffers through said processing elements in a pipelined manner.

10. The method in claim 9, wherein said processing elements are equipped with a local scratchpad memory to hold weights and partial results.
